(19) United States
(12) Patent Application Publication
(10) Pub. No.: US 2020/0168024 A1
(43) Pub. Date: May 28, 2020

(54) PUNCH TAPE AND WRIST STRAP DISPENSER SYSTEM AND METHOD

(71) Applicant: Colleen Murphy, Austin, TX (US)

(72) Inventor: Colleen Murphy, Austin, TX (US)

(21) Appl. No.: 16/751,522

(22) Filed: Jan. 24, 2020

Related U.S. Application Data
(60) Provisional application No. 62/771,688, filed on Nov. 27, 2018.

(51) Int. Cl. G07F 11/00; B65H 1/04; G07F 11/04; A45F 5/00

(52) U.S. Cl. CPC G07F 11/005; B65H 1/04; A45F 2005/008; A45F 5/00; B65H 2402/411; G07F 11/045

(57) ABSTRACT

A lightweight punch tape dispenser that can be worn around the wrist to make punch walks more efficient for project managers, owners, and architects. The device effectively eliminates the need for individuals to walk the site with a roll of painter's tape and tear it off as they go. It dispenses tape in pre-cut segments to make the process easier and less time consuming. The device includes pieces of painter's tape with a non-adhesive section, allowing areas of the tape to easily dispense from the unit. As designed it allows users to quickly remove the tape from a surface where the tape has been applied.

### CROSS-REFERENCE TO RELATED APPLICATION(S)

The present application is related to and claims priority to U.S. Provisional Patent Application No. 62/771,688 filed Nov. 27, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of article dispensing of existing art and more specifically relates to article dispensing for indicia, a punch tape dispenser system.

### RELATED ART

When doing a residential or commercial punch walk, architects, project managers, and owners often walk the site with a roll of painter's tape and tear off individual pieces as they go. This process takes up valuable time and occupies the user's hands, making it difficult to multi-task. In addition, the fully adhesive tape makes it hard to remove the tape from where it has been applied. A suitable solution is desired.

U.S. Pat. No. 5,086,946 to Elmer Blackwell et al., relates to a sheet stack and dispenser package therefor. The described sheet stack and dispenser package includes a stack of individual pre-cut sheets and a dispenser for those sheets. The dispenser affords reciprocating movement of the stack within the dispenser to afford individual dispensing of the sheets. Optionally, the dispenser may be mounted on the wrist of a user to afford convenient dispensing.

### SUMMARY OF THE INVENTION

In view of the foregoing disadvantages inherent in the known article dispensing art, the present disclosure provides a novel punch tape dispenser system. The general purpose of the present disclosure, which will be described subsequently in greater detail, is to provide a means to dispense punch tape in an easy and convenient way.

A punch tape dispenser system is disclosed herein, the system comprising: a punch tape dispenser assembly including a strap; a dispenser head including a body configured to removably receive punch tape (of various sizes) in an inner volume; an upper-guide; and a lower-guide; wherein the punch tape dispenser assembly is configured to permit the punch tape to be dispensed by a user so as to punch-tape-mark objects according to a punch-list.

A method of use for the punch tape dispenser system is also disclosed herein, the method comprising the steps of: providing the punch tape dispenser system, the system comprising a punch tape dispenser assembly including a strap which is adjustable and deformable and is worn about a wrist of a user; a dispenser head including a body configured to removably receive punch tape of various sizes in an inner volume; an upper-guide; and a lower-guide; donning the punch tape dispenser assembly; and sequentially dispensing the punch tape in 1 inch by 1½ inch pre-cut squares. The punch tape has alpha-numeric-indicia and alternately non-alpha-numeric-indicia. A kit is also described for use and sale.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a punch tape dispenser system, constructed and operative according to the teachings of the present disclosure.

FIG. 1 is a perspective view of the punch tape dispenser system during an ‘in-use’ condition, according to an embodiment of the disclosure.

FIG. 2 is a front view of sheets of punch tape of the punch tape dispenser system of FIG. 1, according to an embodiment of the present disclosure.

FIG. 3 is a perspective view of the punch tape as able to be received by the punch tape dispenser system of FIG. 1, according to an embodiment of the present disclosure.

FIG. 4 is a perspective view of the punch tape as sequentially dispensable via the punch tape dispenser system of FIG. 1, according to an embodiment of the present disclosure.

FIG. 5 is a perspective view of the punch tape dispenser system of FIG. 1, in use, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to article dispensing and more particularly to a punch tape dispenser system as used to improve the efficiency of punch-tape-mark objects according to a punch-list.

Generally, Punch Tape and Wrist Band Dispenser is a device designed to make it easier for users to complete punch list walks. The present invention is comprised of a dispenser that preferably includes an elastic strap to allow the user to wear the dispenser around the wrist. The dispenser may be made from a hard plastic and in various sizes to accommodate different widths of tape. One side of the dispenser opens to insert the tape. The included tape has a non-adhesive section to make it easier to pull the tape from the dispenser and to remove the tape after use. The tape may be provided/dispensed in 1″×1.5″, pre-cut squares. Additional options include having tape with letters, numbers, or a chip/sensor to accommodate the categorization and itemization of the items being identified.

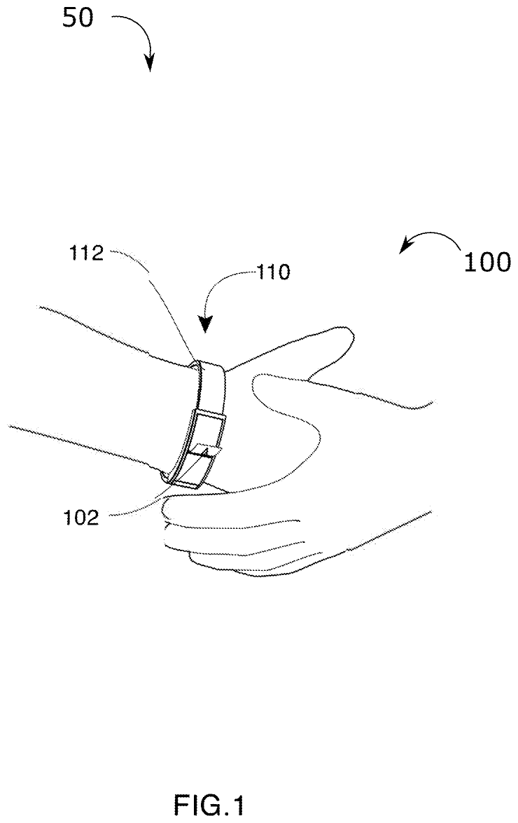

Referring now more specifically to the drawings by numerals of reference, there is shown in FIGS. 1-5, various views of a punch tape dispenser system 100.

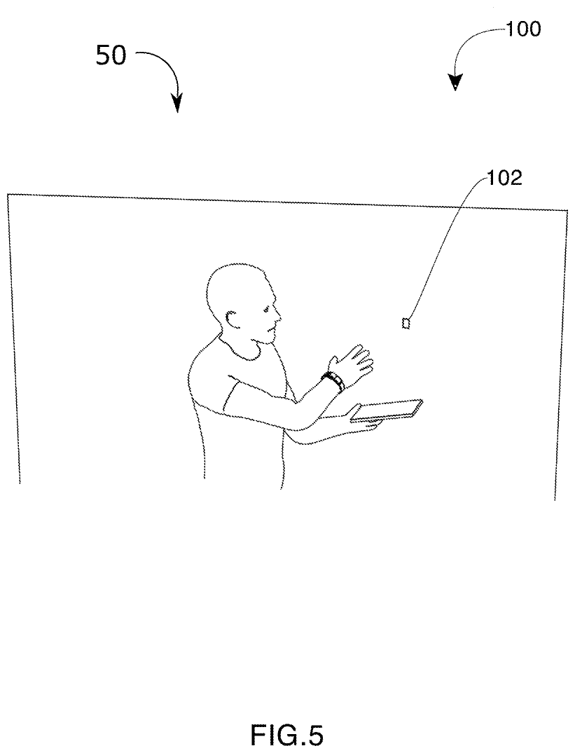

FIGS. 1 and 5 show the punch tape dispenser system 100 during an ‘in-use’ condition 50, according to an embodiment of the present disclosure. Here, the punch tape dispenser system 100 may be beneficial for use by a user to improve the efficiency of punch-tape-mark objects according to a punch-list. As illustrated, the punch tape dispenser system 100 may include a punch tape dispenser assembly 110 including a strap 112; a dispenser head 120 including a body 122 configured to removably receive punch tape 102 of various sizes in an inner volume 124; an upper-guide 126; and a lower-guide 128; wherein the punch tape dispenser assembly 110 is configured to permit the punch tape 102 to be dispensed by a user so as to punch-tape-mark objects according to a punch-list.

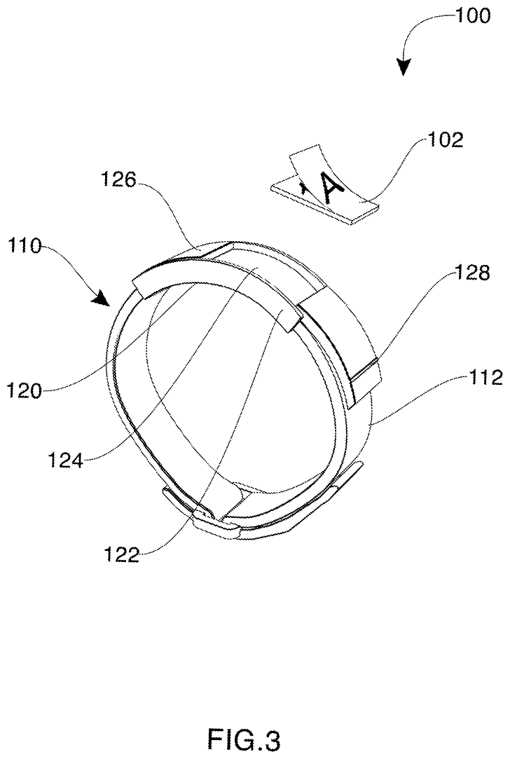

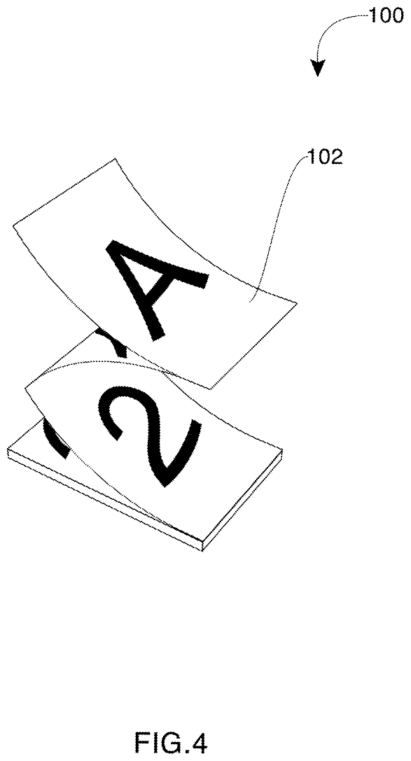

In preferred embodiments the strap 112 (FIG. 3) is deformable and is worn about a wrist of the user (FIG. 1). The strap 112 comprises adjustment and fastening means. The punch tape dispenser assembly 110 is configured to permit the punch tape 102 to be dispensed one by one in series succession (FIGS. 3-4) by the user so as to punch-tape-mark the objects according to the punch-list as shown in FIG. 5.

The lower-guide 128 is able to move in relation to the upper-guide 126 (FIGS. 1 and 3). The lower-guide 128 and the upper-guide 126 of the punch tape dispenser assembly 110 are each arcuately-shaped in preferred embodiments as shown in FIG. 3; wherein the lower-guide 128 when moved away from the upper-guide 126 allows for the punch tape 102 to be received within the inner volume 124 of the body 122. The lower-guide 128 when adjacent to the upper-guide 126 (FIG. 1) allows for the punch tape 102 to be removed sequentially from the inner volume 124 of the body 122 one sheet at a time. The upper-guide 126 is fixed in relation to the body 122 and the lower-guide 128 is non-fixed in relation to the body 122.

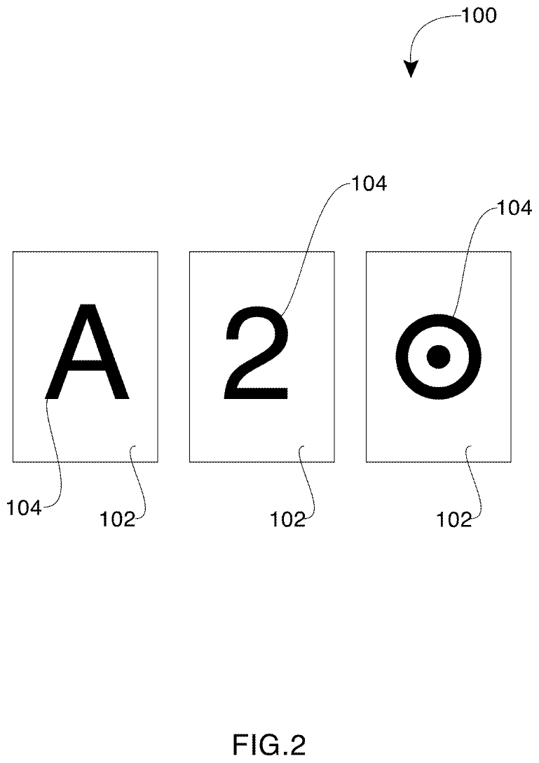

FIGS. 2-4 show the punch tape 102 used with the punch tape dispenser system 100 having indicia 104 on a top-side. The punch tape 102 has a non-adhesive section to make it easier to pull the punch tape 102 from the punch tape dispenser assembly 110 and to remove the punch tape 102 for and after use. The punch tape 102 has alpha-numeric-indicia as shown in FIGS. 3-4 and FIG. 2 shows the punch tape 102 also having non-alpha-numeric-indicia (symbol on far right sheet of punch tape 102). As such the non-alpha-numeric-indicia may comprise symbols. The punch tape 102 preferably comprises 1 inch by 1½ inch pre-cut squares. Other sizes of dispenser head 120 are available.

According to one embodiment, the punch tape dispenser system 100 may be arranged as a kit. In particular, the punch tape dispenser system 100 may further include a set of instructions or a punch list or both. The instructions may detail functional relationships in relation to the structure of the punch tape dispenser system 100 such that the punch tape dispenser system 100 can be used, maintained, or the like, in a preferred manner.

A method of use for the punch tape dispenser system may comprise the steps of: providing the punch tape dispenser system (the system comprising a punch tape dispenser assembly including a strap which is adjustable and deformable and is worn about a wrist of a user; a dispenser head including a body configured to removably receive punch tape of various sizes in an inner volume; an upper-guide; and a lower-guide); donning the punch tape dispenser assembly; and sequentially dispensing the punch tape in 1 inch by 1½ inch pre-cut squares. The punch tape has alpha-numeric-indicia and alternately non-alpha-numeric-indicia.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for punch tape dispenser system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A punch tape dispenser system, the system comprising:
a punch tape dispenser assembly including
a strap;
a dispenser head including
a body configured to removably receive punch tape of various sizes in an inner volume;
an upper-guide; and
a lower-guide;
wherein said punch tape dispenser assembly is configured to permit said punch tape to be dispensed by a user so as to punch-tape-mark objects according to a punch-list.

2. The punch tape dispenser system of claim 1, wherein said strap is deformable and is worn about a wrist of the user.

3. The punch tape dispenser system of claim 1, wherein said punch tape dispenser assembly is configured to permit said punch tape to be dispensed one by one in series succession by said user so as to punch-tape-mark said objects according to said punch-list.

4. The punch tape dispenser system of claim 1, wherein said lower-guide is able to move in relation to said upper-guide.

5. The punch tape dispenser system of claim 4, wherein said lower-guide and said upper-guide are each arcuately-shaped.

6. The punch tape dispenser system of claim 5, wherein the lower-guide when moved away from the upper-guide allows installation into the inner volume of the body. The punch tape dispenser system of claim 5, wherein the lower-guide when adjacent to said upper-guide opening into a dispensing configuration allows sequential, one-by-one sheet removal from said inner volume of said body one sheet at a time.

8. The punch tape dispenser system of claim 7, wherein said upper-guide is fixed in relation to said body.

9. The punch tape dispenser system of claim 7, wherein said lower-guide is movable in relation to said body.

10. The punch tape dispenser system of claim 1, wherein the strap comprises adjustment and fastening means.

11. The punch tape dispenser system of claim 1, wherein the punch tape has indicia on a top-side.

12. The punch tape dispenser system of claim 1, wherein the punch tape has a non-adhesive section to make it easier to pull the punch tape from the punch tape dispenser assembly and to remove the punch tape after use.

13. The punch tape dispenser system of claim 11, wherein the punch tape has alpha-numeric-indicia.

14. The punch tape dispenser system of claim 11, wherein the punch tape has non-alpha-numeric-indicia.

15. The punch tape dispenser system of claim 14, wherein the indicia comprise symbols.

16. The punch tape dispenser system of claim 11, wherein the punch tape comprises 1 inch by 1½ inch pre-cut squares.

17. A punch tape dispenser system, the system comprising:
a punch tape dispenser assembly including
a strap which is adjustable;
a dispenser head including
a body configured to removably receive punch tape of various sizes in an inner volume;
an upper-guide; and
a lower-guide;
wherein said strap is deformable and is worn about a wrist of a user;
wherein said lower-guide is able to move in relation to said upper-guide;
wherein said lower-guide and said upper-guide are each arcuately-shaped;
wherein the lower-guide when moved away from said upper-guide allows for said punch tape to be received within said inner volume of said body;
wherein the lower-guide when adjacent to said upper-guide allows for said punch tape to be removed sequentially from said inner volume of said body one sheet at a time;
wherein said upper-guide is fixed in relation to said body;
wherein said lower-guide is non-fixed in relation to said body;
wherein the punch tape has indicia on a top-side;
wherein the punch tape has a non-adhesive section to make it easier to pull the punch tape from the punch tape dispenser assembly and to remove the punch tape after use;
wherein the punch tape has alpha-numeric-indicia and alternately non-alpha-numeric-indicia;
wherein said punch tape dispenser assembly is configured to permit said punch tape to be dispensed by the user so as to punch-tape-mark objects according to a punch-list;
wherein said punch tape dispenser assembly is configured to permit said punch tape to be dispensed one by one in series succession by said user so as to punch-tape-mark said objects according to said punch-list; and
wherein the punch tape comprises 1 inch by 1½ inch pre-cut squares.

18. The punch tape dispenser system of claim 17, further comprising set of instructions; and
wherein the punch tape dispenser system is arranged as a kit.

19. A method comprising:
donning the punch tape dispenser system of claim 1;
conducting a punch list walk through a building;
dispensing said punch tape;
marking defects in the building with the punch tape;
and
annotating the punch list to index to the punch-tape-marked defect.

20. The method of claim 19, wherein said punch tape has indicia to facilitate annotating the punch list.
